(19) United States
(12) Patent Application Publication
(10) Pub. No.: US 2003/0209946 A1
(43) Pub. Date: Nov. 13, 2003

(54) Heat-dissipated mechanism for outer-rotor type brushless DC motor

(76) Inventors: Shih-ming Huang, Hsin Chu (TW); Wen-shi Huang, Chung Li City (TW)

Correspondence Address: MARTINE & PENILLA, LLP, 710 LAKEWAY DRIVE, SUITE 170, SUNNYVALE, CA, 94085, US

(21) Appl. No.: 10/178,969

(22) Filed: Jun. 24, 2002

(30) Foreign Application Priority Data
May 7, 2002 (TW) 91206441

(51) Int. Cl. H02K 9/00

(52) U.S. Cl. 310/58

(57) ABSTRACT

An outer-rotor type brushless motor is provided, wherein the outer edge of a stator of the outer-rotor type brushless motor is surrounded in the cup-shaped outer periphery of a rotor case of a rotor thereof, and the rotor is rotated with respect to the stator. The outer-rotor type brushless motor is characterized in that at least one projection and a corresponding opening thereof are formed on a surface of the rotor case, so that the projection and the corresponding opening thereof are rotated together with the rotation of the rotor, thereby heat generated by the stator is dissipated.

### BACKGROUND OF THE INVENTION

1. Field of the Invention

The present invention relates to an outer-rotor type brushless motor, and more particularly, to an outer-rotor type brushless DC motor with forced-ventilation mechanism.

2. Description of the Related Art

Please refer to FIG. 1, a partially cross sectional view of a conventional outer-rotor type brushless DC motor 100 is illustrated.

As shown in FIG. 1, the conventional outer-rotor type brushless DC motor 100 comprises a rotor 101, a bearing assembly 201, a stator 301 and a plate 401. The rotor 101 is constituted by a shaft 102, a rotor case 104 which has a central portion fixed to the shaft 102 through a hub 103, and a permanent magnet 105 provided on an inner surface of a cup-shaped outer periphery of the rotor case 104. The bearing assembly 201 comprises at least one bearing 202 and a bearing housing 203, wherein the at least one bearing 202 is provided between the shaft 102 and an inner surface of the bearing housing 203. The stator 301 includes a plurality of silicon steel sheets 302 radially fixed to an outer surface of the bearing housing 203 and a set of coils 303 wound around each silicon steel sheet 302, wherein the cup-shaped outer periphery of the rotor case 104 encloses an outer edge of the stator 301, and the rotor 101 is rotated with respect to the stator 301. Furthermore, the plate 401 is fixed to the bearing housing 203 so as to support the outer-rotor type brushless DC motor 100.

However, when the conventional outer-rotor type brushless DC motor 100 runs, heat generated from the stator 301 enclosed in the DC motor 100 can not be dissipated effectively, resulting in the rated temperature of the running DC motor 100 being unable to reduce, and then the efficiency of the DC motor 100 being deteriorated at high temperature.

In view of the above, it is required an outer-rotor type brushless motor capable of reducing the temperature resulted from the running thereof and increasing the efficiency thereof.

### SUMMARY OF THE INVENTION

Thus, it is an object of the present invention to provide an outer-rotor type brushless DC motor capable of reducing the temperature resulted from the running thereof and increasing the efficiency thereof.

The outer-rotor type brushless motor is provided according to one embodiment of the present invention, wherein a cup-shaped outer periphery of a rotor case of a rotor of the outer-rotor type brushless DC motor encloses an outer edge of a stator thereof, and the rotor is rotated with respect to the stator; the outer-rotor type brushless DC motor is characterized in that: at least one projection and an opening corresponding to the at least one projection are formed on a surface of the rotor case, so that the projection and the corresponding opening thereof are rotated together with the rotation of the rotor, thereby heat generated by the stator is dissipated.

It is preferred that the at least one projection connected to the surface of the rotor case at at least one side is inwardly or outwardly configured to have a shape thereof and the opening.

A heat-dissipated mechanism for an outer-rotor type brushless DC motor is provided according to another embodiment of the present invention, wherein a cup-shaped outer periphery of a rotor case of a rotor of the outer-rotor type brushless DC motor encloses an outer edge of a stator thereof, and the rotor is rotated with respect to the stator; the heat-dissipated mechanism is characterized in that: at least one projection and an opening corresponding to the at least one projection are formed on a surface of the rotor case, so that the projection and the corresponding opening thereof are rotated together with the rotation of the rotor, thereby heat generated by the stator is dissipated.

It is preferred that the at least one projection connected to the surface of the rotor case at at least one side thereof is inwardly or outwardly configured to have a shape thereof and the opening.

### BRIEF DESCRIPTION OF THE DRAWINGS

FIG. 1 illustrates a partially cross sectional view of the conventional outer-rotor type brushless DC motor.

FIG. 2 illustrates a partially cross sectional view of the outer-rotor type brushless DC motor according to an embodiment of the present invention.

FIGS. 3A to 3C illustrate side views of the modified projections and openings viewed along the lateral direction in FIG. 2.

FIG. 4 illustrates a cross sectional view of the projection and opening according to another modification of FIG. 2.

FIG. 4A illustrates a side view of the projection and opening viewed along the lateral direction in FIG. 4.

FIG. 5 illustrates a cross sectional view of the projection and opening according to still another modification of FIG. 2.

FIG. 5A illustrates a side view of the projection and opening viewed along the lateral direction in FIG. 5.

FIG. 6 illustrates a side view of the heat-dissipated mechanism of the outer-rotor type brushless DC motor according to another embodiment of the present invention.

### DETAILED DESCRIPTION OF THE PREFERRED EMBODIMENT

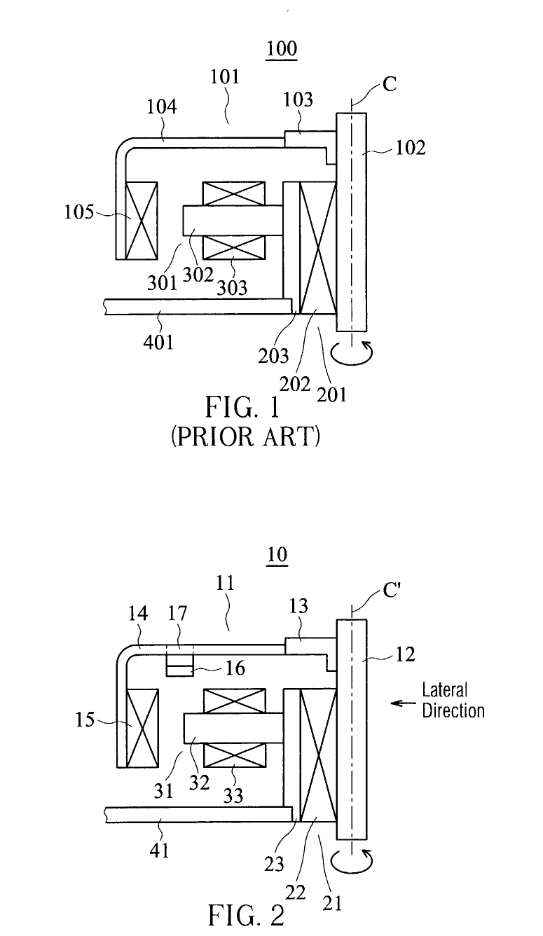

Please refer to FIG. 2, a partially cross sectional view of an outer-rotor type brushless DC motor 10 according to an embodiment of the present invention is illustrated.

As shown in FIG. 2, the outer-rotor type brushless DC motor 10 also comprises a rotor 11, a bearing assembly 21, a stator 31 and a plate 41. The rotor 11 is constituted by a shaft 12, a rotor case 14 which has a central portion fixed to the shaft 12 through a hub 13, and a permanent magnet 15 provided on an inner surface of a cup-shaped outer periphery of the rotor case 14. The bearing assembly 21 comprises at least one bearing 22 and a bearing housing 23, wherein the at least one bearing 22 is provided between the shaft 12 and an inner surface of the bearing housing 23. The stator 31 includes a plurality of silicon steel sheets 32 radially fixed to an outer surface of the bearing housing 23 and a set of coils 33 wound around each silicon steel sheet 32, wherein the cup-shaped outer periphery of the rotor case 14 encloses an outer edge of the stator 31, and the rotor 11 is rotated with respect to the stator 31. Furthermore, the plate 41 is fixed to the bearing housing 23 so as to support the outer-rotor type brushless DC motor 10.

Specifically, as shown in FIG. 2, the outer-rotor type brushless DC motor 10 is characterized in that at least one projection 16 and a corresponding opening 17 thereof are formed on a surface of the rotor case 14, so that the projection 16 and the corresponding opening 17 thereof are rotated together with the rotation of the rotor 11, thereby heat generated from the stator 31 is dissipated.

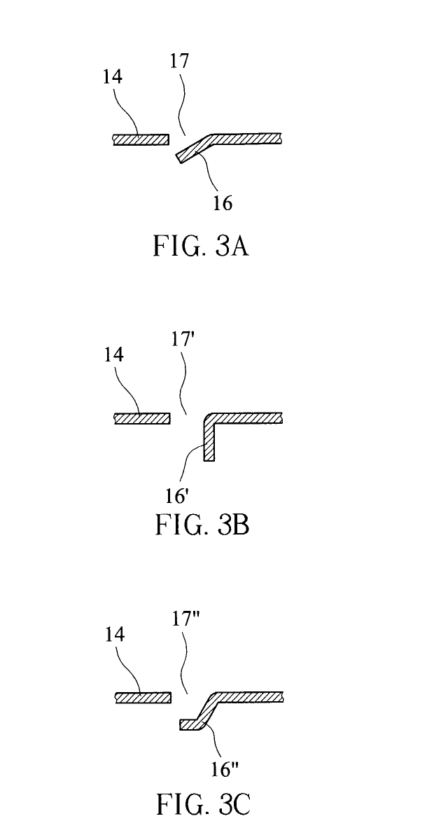

Please refer to FIGS. 3A to 3C, illustrating side views of the modified projections and openings viewed along the lateral direction in FIG. 2.

As shown in FIG. 3A, the projection 16 connected to the surface of the rotor case 14 at one side is inwardly configured to have a shape thereof and the opening 17. Preferably, the projection 16 and opening 17 are configured by means of stamping. Therefore, the projection 16 and opening 17 function as a structure of fan blades while both of them are rotated together with the rotation of the rotor 11, thereby an air flow caused by the forced ventilation is occurred in the outer-rotor type brushless DC motor 10, so that it is possible to dissipate the heat generated from the stator 31, resulting in reducing the rated temperature of the running motor 10 effectively and increasing the efficiency of the motor 10.

As shown in FIG. 3B, a modification of the projection 16 and opening 17 in FIG. 3A is illustrated, wherein a projection 16′ is formed into one perpendicular to the surface of the rotor case 14, and an opening 17′ is formed on the surface of the rotor case 14 after the projection 16′ is formed.

As shown in FIG. 3C, another modification of the projection 16 and opening 17 in FIG. 3A is illustrated, wherein the one end of a projection 16″ disconnected from the surface of the rotor case 14 is formed into one substantially parallel to the surface of the rotor case 14, and an opening 17″ is formed on the surface of the rotor case 14 after the projection 16″ is formed.

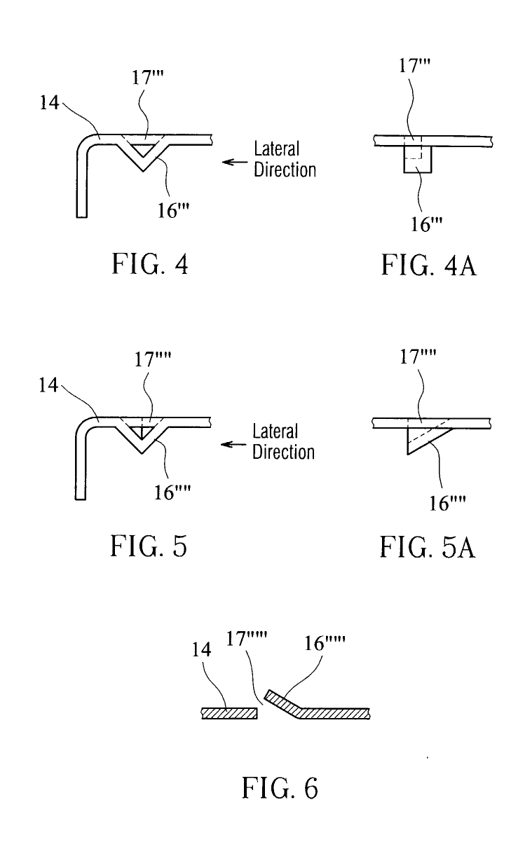

Please refer to FIGS. 4 and 4A, a projection 16′″ and opening 17′″ according to another modification of FIG. 2 are illustrated. FIG. 4A illustrates a side view of the projection 16′″ and opening 17′″ viewed along the lateral direction in FIG. 4. As shown in FIGS. 4 and 4A, the projection 16′″ connected to the surface of the rotor case 14 at two side is inwardly configured to have a shape thereof and the opening 17′″. Preferably, the projection 16′″ and opening 17′″ are configured by means of stamping.

Please refer to FIGS. 5 and 5A, a projection 16″″ and opening 17″″ according to still another modification of FIG. 2 are illustrated. FIG. 5A illustrates a side view of the projection 16″″ and opening 17″″ viewed along the lateral direction in FIG. 5. As shown in FIGS. 5 and 5A, the projection 16″″ disconnected to the surface of the rotor case 14 merely at one side is inwardly configured to have a shape thereof and the opening 17″″. Preferably, the projection 16″″ and opening 17″″ are configured by means of stamping.

It is to be appreciated that one of ordinary skill in the art can change or modify the embodiment or the modifications without departing from the spirit of the present invention. For example, FIG. 6 illustrates the heat-dissipated mechanism of the outer-rotor type brushless DC motor 10 according to another embodiment of the present invention, wherein a projection 16′″″ connected to the surface of the rotor case 14 at one side is outwardly configured to have a shape thereof and an opening 17′″″. Further, the modifications of FIG. 6 can be accomplished easily by persons skilled in the art after referring to FIGS. 3A to 3C, 4 and 5.

Although the foregoing invention has been described in some detail for purposes of clarity of understanding, it will be apparent that certain changes and modifications may be practiced within the scope of the appended claims. Accordingly, the present embodiments are to be considered as illustrative and not restrictive, and the invention is not to be limited to the details given herein, but may be modified within the scope and equivalents of the appended claims.

What is claimed is:

1. An outer-rotor type brushless DC motor, wherein a cup-shaped outer periphery of a rotor case of a rotor of the outer-rotor type brushless DC motor encloses an outer edge of a stator thereof, and the rotor is rotated with respect to the stator;
the outer-rotor type brushless DC motor is characterized in that:
at least one projection and an opening corresponding to the at least one projection are formed on a surface of the rotor case, so that the projection and the corresponding opening thereof are rotated together with the rotation of the rotor, thereby heat generated by the stator is dissipated.

2. The motor as recited in claim 1, wherein the at least one projection connected to the surface of the rotor case at at least one side is inwardly configured to have a shape thereof and the opening.

3. The motor as recited in claim 1, wherein the at least one projection connected to the surface of the rotor case at at least one side is outwardly configured to have a shape thereof and the opening.

4. A heat-dissipated mechanism for outer-rotor type brushless DC motor, wherein a cup-shaped outer periphery of a rotor case of a rotor of the outer-rotor type brushless motor encloses an outer edge of a stator thereof, and the rotor is rotated with respect to the stator;
the heat-dissipated mechanism is characterized in that:
at least one projection and an opening corresponding to the at least one projection are formed on a surface of the rotor case, so that the projection and the corresponding opening thereof are rotated together with the rotation of the rotor, thereby heat generated by the stator is dissipated.

5. The heat-dissipated mechanism as recited in claim 4, wherein the at least one projection connected to the surface of the rotor case at at least one side is inwardly configured to have a shape thereof and the opening.

6. The heat-dissipated mechanism as recited in claim 4, wherein the at least one projection connected to the surface of the rotor case at at least one side is outwardly configured to have a shape thereof and the opening.
